(19) United States
(12) Patent Application Publication
(10) Pub. No.: US 2017/0322138 A1
(43) Pub. Date: Nov. 9, 2017

(54) SYSTEMS AND METHODS FOR MANIPULATING FLOW CYTOMETRIC DATA

(71) Applicant: Becton, Dickinson and Company, Franklin Lakes, NJ (US)

(72) Inventors: Christopher J. Wolf, San Jose, CA (US); David A. Roberts, San Jose, CA (US)

(21) Appl. No.: 15/435,140

(22) Filed: Feb. 16, 2017

Related U.S. Application Data
(60) Provisional application No. 62/333,771, filed on May 9, 2016.

(51) Int. Cl. G01N 15/14; G06F 3/0484; G06T 11/20

(52) U.S. Cl. CPC G01N 15/1429; G06T 11/206; G01N 15/1404; G06F 3/04847

(57) ABSTRACT

Automated cell sorters are provided. Aspects of the systems include an image based automated stream adjuster. Also provided are methods of using the automated cell sorters.

### CROSS-REFERENCE TO RELATED APPLICATION

Pursuant to 35 U.S.C. §119(e), this application claims priority to the filing date of U.S. Provisional Patent Application No. 62/333,771, filed May 9, 2016; the disclosure of which application is herein incorporated by reference.

### INTRODUCTION

Flow cytometers are used for analyzing and sorting particles in a fluid sample, such as cells of a blood sample or particles of interest in any other type of biological or chemical sample. A flow cytometer typically includes a sample reservoir for receiving a fluid sample, such as a blood sample, and a sheath reservoir containing a sheath fluid. The flow cytometer transports the particles (hereinafter called “cells”) in the fluid sample as a cell stream to a flow cell, while also directing the sheath fluid to the flow cell.

Within the flow cell, a liquid sheath is formed around the cell stream to impart a substantially uniform velocity on the cell stream. The flow cell hydrodynamically focuses the cells within the stream to pass through the center of a laser beam in a flow cell. The point at which the cells intersect the laser beam is commonly known as the interrogation point. As a cell moves through the interrogation point, it causes the laser light to scatter. The laser light also excites components in the cell stream that have fluorescent properties, such as fluorescent markers that have been added to the fluid sample and adhered to certain cells of interest, or fluorescent beads mixed into the stream. The flow cytometer includes an appropriate detection system consisting of photomultiplier tubes, photodiodes or other light detecting devices, which are focused at the intersection point. The flow cytometer analyzes the detected light to measure physical and fluorescent properties of the cell. The flow cytometer can further sort the cells based on these measured properties. The flow stream exits the flow cell via a nozzle with a nozzle diameter that is appropriate for the fluidics system and sort rate desired.

To sort cells by an electrostatic method, the desired cell must be contained within an electrically charged droplet. To produce droplets, the flow cell is rapidly vibrated by an acoustic device, such as a piezoelectric element. The volume of a droplet is conventionally estimated by the hydrodynamic properties of the flow stream and the nozzle dimensions. To charge the droplet, the flow cell includes a charging element whose electrical potential can be rapidly changed. Because the cell stream exits the flow cell in a substantially downward vertical direction, the droplets also propagate in that direction after they are formed. Droplets, whether they are charged or are uncharged must be collected in a sample collection vessel that is appropriately directed to collect the one or more flow streams generated by the deflection plates. Accordingly, the droplets and the cells contained therein may be collected in appropriate collection vessels downstream of the plates.

In using flow cytometers, the flow stream and collection vessels are conventionally manually aligned. The fluidics parameters such as flow rate and sheath fluid composition must be matched with an appropriate nozzle diameter.

### SUMMARY

Systems and methods for manipulating flow cytometric data are provided.

### BRIEF DESCRIPTION OF THE FIGURES

FIG. 1 provides an illustration Biexponential Controls Before Adjustment according to an embodiments of the invention.

FIG. 2 provides an illustration Biexponential Controls After Adjustment according to an embodiments of the invention.

FIG. 3 provides a Flow Diagram for Biexponential Control.

FIG. 4 provides a illustration of four types of plots that can be rendered according to an embodiment of the invention.

FIG. 5 provides an illustration of a dotplot according to an embodiment of the invention.

FIG. 6 provides an illustration of a histogram according to an embodiment of the invention.

FIG. 7 provides an illustration of a density/color graph according to an embodiment of the invention.

FIG. 8 provides an illustration of a binary format that may be employed in embodiments of the invention.

FIG. 9 provides an illustration of a flow diagram according to an embodiments of the invention.

### DETAILED DESCRIPTION

Systems and methods for manipulating flow cytometric data are provided.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The following examples are offered by way of illustration, and not by way of limitations.

### EXPERIMENTAL

Details regarding two different embodiments, which may or may not be used in combination, for manipulating flow cytometric data are now reviewed in greater detail.

### A. A Novel Approach to Modifying the Biexponential Algorithm in a Plot Using a Simple Custom Control

A Novel Approach for Modifying Biexponential Scaling for a Display Plot Using Feedback

A Novel Approach for Modifying Biexponential Scaling for a Display Plot. By utilizing controls directly on a plot, the user can manually control the Biexponential scaling algorithm in both dimensions. This helps to visualize the data in a way that helps the user understand the data and manipulate it. When the user modifies the algorithm, there is instantaneous feedback in the plot.

The Biexponential Algorithm (also called Logicle Scaling) is used to display Flow Data in a way that data at the low end of the graph that is below zero can be visualized. While the algorithm is used in many Flow applications, this invention allows a user to adjust the scale quickly while getting feedback at the same time.

Controls that are placed directly on the plot allow the user to ‘tune’ the scale with a simple user interface control.

This invention allows simple up/down control directly on the plot in question resulting in immediate feedback. The user maintains focus on the data in question allowing the user to quickly fine-tune the scale. The control when clicked modifies the algorithm parameters. Immediately after this change a redraw of the axes and data is performed resulting in the instant feedback.

When displaying Flow Data in Plots, there is a need to use more than just linear data or logarithmic data. There is an additional scale that the can be used. Biexponential (aka Logicle) scaling is a hybrid of Log and Linear. It allows users to see the negative data that would otherwise be piled up on the axes in a logarithmic plot.

Flow Data Software currently supports Biexponential scale and there is a need to ‘tune’ it by modifying control parameters for the algorithm. Current software typically uses a textbox in a form that the user types in information, selects apply and then redraws the plots. Unfortunately this requires several iterations to ‘get it right.’

Aspects of the invention are directed to a technique to allow the user to quickly adjust the biexponential parameters and to see the result.

### 1. Biexponential Controls Directly in the Plot

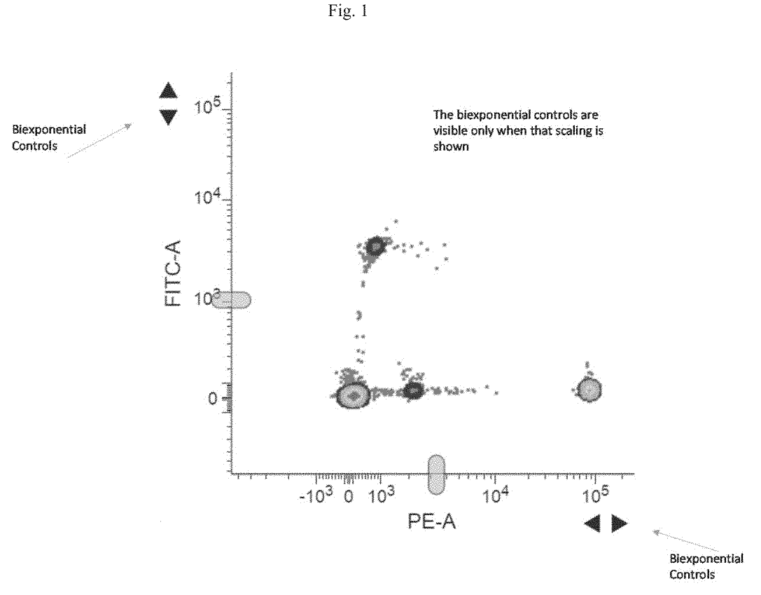

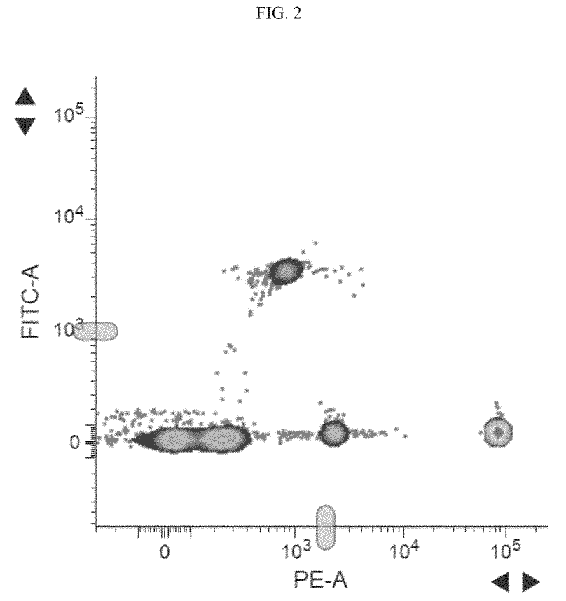

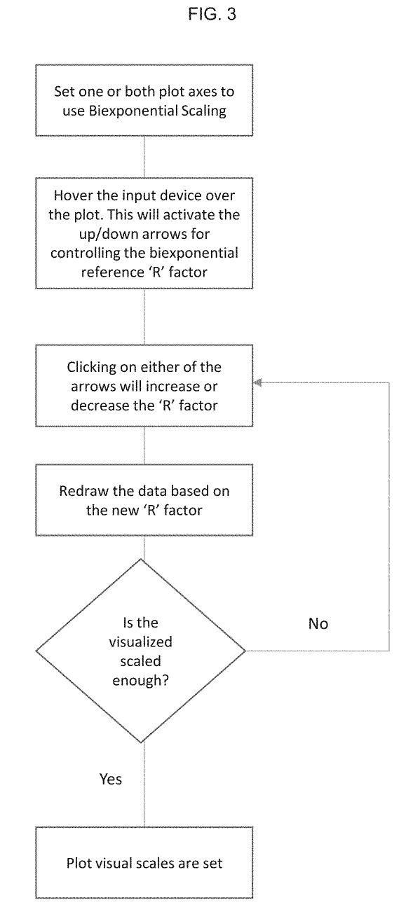

The approach adds a custom control containing up/down arrows that are displayed when biexponential scaling is active. When the user clicks on the arrows the parameters are modified and the plot immediately redrawn. FIG. 1 shows the controls. After adjustment the axes and data will be redrawn as shown in FIG. 2. After adjustment we can see that there are actually two populations in the data in the lower-left corner. This is a simple and effective way for the user to quickly modify visualization using the Biexponential algorithm. FIG. 3 provides a Flow Diagram for Biexponential Control.

### B. A Technique for Displaying Real-Time Flow Cytometer Graphics in a Web Browser

A Technique for Displaying Real-time Flow Cytometer Graphics in a Web Browser. Using a novel storage techniques and a fast transmission protocol, real-time graphics for plots and statistics can be displayed in the web browser.

During instrument acquisition and analysis, Flow Cytometer graphics consist of displaying Dot Plots, Histograms, Contours, and Density Plots. The data driving these plots is large and displaying these in a web browser would overwhelm the web browser. This invention describes the compact way of storing information for these plot types and how this information can be transmitted over a standard protocol using a custom data stream format. The result is that near real-time display of data can occur in the browser. The technique uses standard websocket technology to transmit the data from the computer to the web browser. The key to efficiency is to have a compact description of the data needed in the plots. Since this technique uses a standard web browser technology, it can run on multiple platform types.

Three aspects of embodiments of the invention include:

1. A compact description of the plot data—the data is a histogram that describes the plot data. Raw flow event data is not used.

2. A binary stream format to be delivered to the Web Browser

3. A fast protocol to connect to the web browser, Web Socket in this case

### 1. Instruction

1.1. Purpose
The purpose of this document is to define the Binary Stream Format used to transmit analysis computation results in Simplexity 1.0.

1.2. Scope
This document describes data structures used to store results for visualization along with the binary stream format used to transmit the results to be used by Simplexity and the rationale.

1.3. Safety Classification

1.4. References

| Document | Version | Date |
|---|---|---|
| Simpiexity 1.0 SW Architecture Design | 1.0 | |

### 2. Design

2.1. Background
The instrument data acquisition electronics produces a large number of parameters for each event. These parameters are sent from the instrument to the workstation in what is known as an Array Of Structures (AoS) layout.
Example, for a 4 color file (Time, plus FSC, SSC and FL1 thru FL4) with 19 distinct parameters:

| | | | | | | | | | | |
|---|---|---|---|---|---|---|---|---|---|---|
| Memory location | 0 | 4 | 8 | 12 | 16 | 20 | 24 | 28 | . . . | 76 |

| | | | | | | | | | |
|---|---|---|---|---|---|---|---|---|---|
| Contents | Time | FSC-A | FSC-W | FSC-H | SSC-A | SSC-W | SSC-W | FL1-A | Time |

This is a very natural layout to use, especially for the instrument electronics. As the number of colors increases, the number of parameters (or channels) increases.

2.1.1. Visualization (Rendering)
On the user side (the browser), a set of plots is created that allow the user a view into the data. Each plot can display one or two parameters. So typically a user will setup some number of plots ranging from a few to a couple dozen.
This set of plots is valuable in deciding which parameters should be processed for drawing and calculating statistics and helps to avoid having to compute all of the parameters.
In addition to creating multiple plots, the user can determine what types of plots are displayed. There are currently four types of plots that can be rendered:
   Dot plots—A two-dimensional display useful for viewing multiple population types
   Histograms—A one-dimension display useful for viewing counts of events
   Contours—A two-dimensional display useful for viewing density of data
   Density—A alternate way to display data density

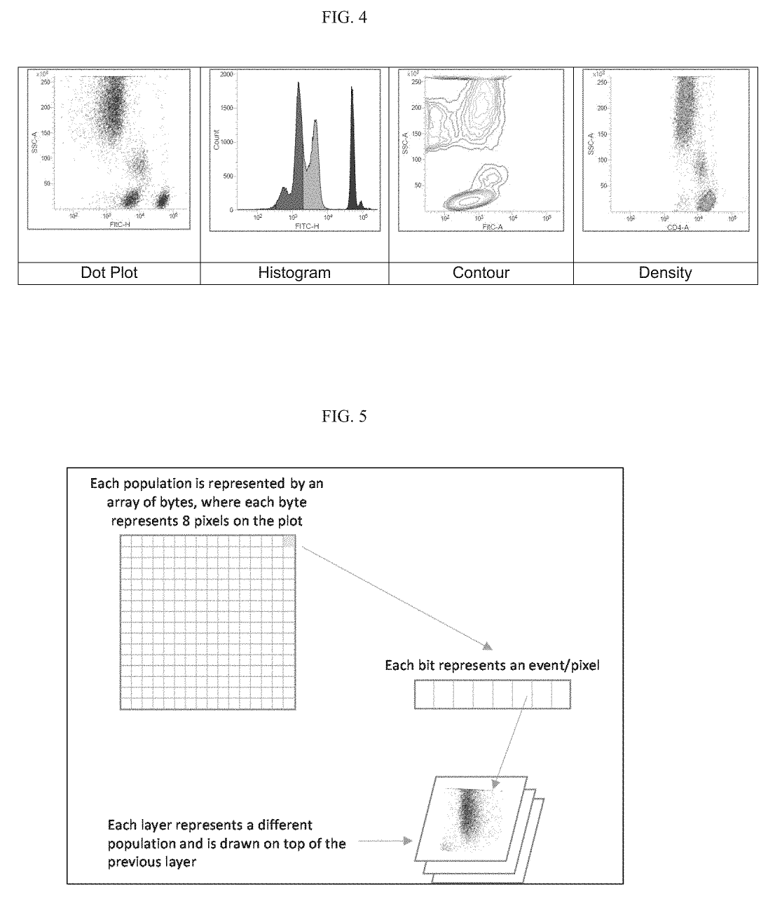

### See FIG. 4.

To render the data quickly, the key is to avoid referencing raw data events. If this occurs there are several issues to consider.
   The rendering code has to be aware of the data storage of the raw events. Any change to the storage layout would also mean modifying the rendering code
   The amount of raw data can be extraordinarily huge, meaning that each display would have to traverse through the raw data which is a very time-consuming task
   You want rendering to occur as quickly as possible so that the user interface is not ‘locked up’
Sending all of the data over to the browser would require a very high-bandwidth connection
The same issues apply to calculating statistics. Only the statistics that the user is concerned with should be displayed and computed. Again the code to calculate the statistics should not be in the rendering code.

2.1.2. Data Transmission
The other concern, is how to efficiently represent the data in a small enough package that can be transmitted quickly to the browser. The plots should render data frames at least 10 fps (frames per second.) The statistics update at an approximate of 2 fps.
The browser supports the HTTP protocol that is the standard protocol for processing and transmitting web pages. While this is usually fast enough for the display of HTML pages, it is inadequate for sending data at the required rate for the plots. There is an overhead for each packet due to handshaking. Additionally using HTTP would require a timer to constantly request data from the server.
The data packets themselves should be small so transmission of the data is quick. Also being small would allow the rendering in the plots to be quick.

2.2. New Design
With this background, a design that minimizes the amount of data to be sent to the rendering engine is necessary.
The design addresses two concerns:
   How to represent the data to be rendered
   How to transmit the data to the browser

2.3 Transmission Protocol
Another protocol supported by newer browsers is the WebSocket protocol. It has several advantages over the older HTTP protocol:
   WebSocket allows a minimal handshake setup each subsequent packet has a minimal overhead
   Once the connection is established, the connection is always on until disconnected.
   The protocol supports both textual and binary data
   Custom messaging is required, but this allows optimization of messages

2.4 Compact Computation Results
Each plot type uses a particular data structure to represent the data results. The results are output of the compute engine on the backend of the application.

2.4.1 DotPlot
The dotplot displays populations of data in a scatter plot. Each event is represented by a dot or pixel on the screen. If there are three different populations drawn on the plot, than three different colors are used. Each population is represented in its own data structure which results in a layering effect on the plot. This structure is typically 256×256 in size so this works out to exactly 8192 bytes for each layer in the plot. This is a huge space savings compared to having to iterate through all of the events. See FIG. 5.

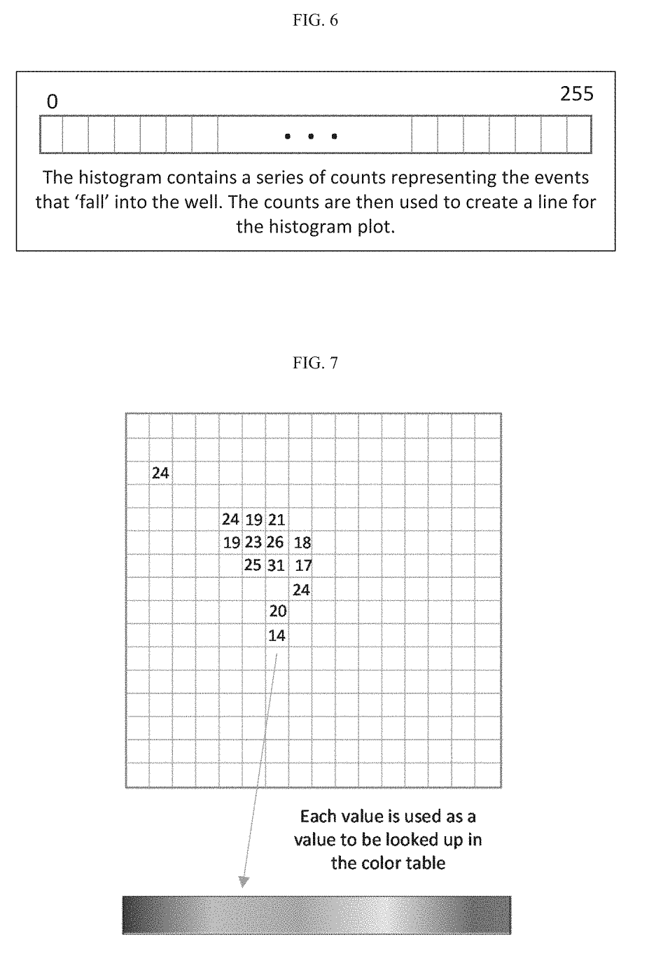

2.4.2 Histogram
The histogram is represented by an array of integers. Typically 256 in length, the values in the histogram are used to render a line in the plot. For a histogram using 256 integers, the size is 1024 bytes. See FIG. 6

2.4.3 Density and Contour
The density and contour both display data using color as an indicator of data density. The data structure used is a two-dimensional histogram. This histogram uses a 32-bit integer to store the count of events that lie within each cell. The count within the cell is used to calculate the color used to fill in the cell. Typically only one population is drawn on a density/contour plot. A different algorithm is used to render the contour and density. See FIG. 7.

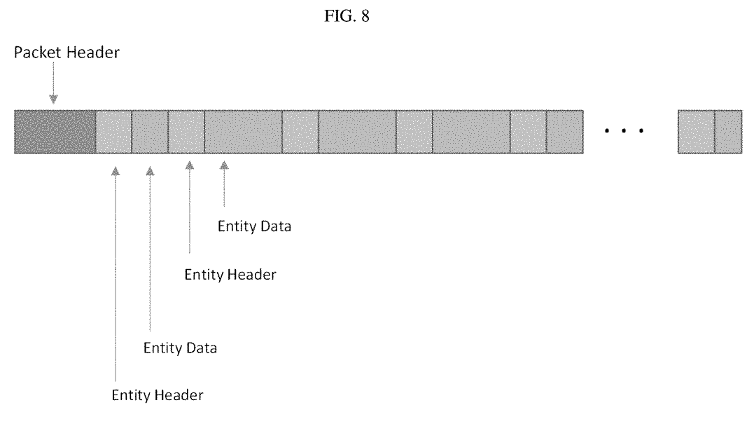

2.5 Binary Streams Format
This is the custom binary format that is sent ‘over the wire’ using the WebSocket protocol. A binary format is used instead of a textual format since a significant space savings can be realized. Additionally since the data is binary, it has a format identical to the in-memory format used by the browser so there are minimal costs for serializing and deserializing. This results in a time savings during processing. All numbers are encoded with little Endian unless otherwise noted.
When a packet is transmitted it always consists of a master header followed by the data structures for each plot. The master header describes how many general information about the package and the entities that are to follow. Each entity consists of a sub-header and the data. See FIG. 8

2.6 Entity Format for Over-the-Wire Transmission

Header

| Offset | Type | Content | |
|---|---|---|---|
| 0 | 4 byte char | ‘BDIS’ | Four byte header |
| | | | indicating that this |
| | | | came from the |
| | | | application stack. |
| | | | BDIS = BD |
| | | | Immunocytometry |
| | | | Systems. This can |
| | | | also be used as a |
| | | | sentinel for detecting |
| | | | endianness issues |
| | | | between client and |
| | | | server. |
| 4 | 32 bit unsigned | Header Structure | Used for versioning. |
| | int | size | 36 for the version in |
| | | | this document |
| 8 | 32 bit unsigned | Sequence number | Sequential identifier of |
| | int | | messages being |
| | | | transmitted. Rolls over. |
| 12 | 32 bit unsigned | Total message | Length of message |
| | int | length | including headers |
| 16 | char[16] | Experiment | String, or QUID, used |
| | | identifier | to identify the |
| | | | experiment |
| 32 | 32 bit unsigned | Number of entities | Number of entities |
| | int | within message | within the message |
| 36 | | Start of entities | |

1P Histogram

| Offset | Type | Content | |
|---|---|---|---|
| 0 | 32 bit unsigned | 0 | Type of entity. 0 for a |
| | int | | single parameter |
| | | | histogram. |
| 4 | 32 bit unsigned | Length | Length in bytes of |
| | int | | entity including |
| | | | headers |
| 8 | 32 bit unsigned | Plot ID | Must be unique within |
| | int | | the message |
| 12 | 32 bit unsigned | Number of | Only 256 is currently |
| | int | channels in the | supported |
| | | histogram | |
| 16 | 32 bit unsigned | Compression | Method of |
| | int | method | compression. 0 is no |
| | | | compression |
| 20 . . . | 32 bit unsigned | Count of events in | Repeats for |
| | int | bin 0 of the | subsequent bins |
| | | histogram | |

2P Histogram (Contour and Density)

| Offset | Type | Content | |
|---|---|---|---|
| 0 | 32 bit unsigned | 1 | Type of entity. 1 for a |
| | int | | dual parameter |
| | | | histogram. |
| 4 | 32 bit unsigned | Length | Length in bytes of |
| | int | | entity including |
| | | | headers |
| 8 | 32 bit unsigned | Plot ID | Must be unique within |
| | int | | the message |
| 12 | 32 bit unsigned | Number of | Only 256 and 64 are |
| | int | channels in the | currently supported, |
| | | histogram | and the histogram |
| | | | must be square, i.e. |
| | | | 256x256 |
| 16 | 32 bit unsigned | Compression | Method of |
| | int | method | compression. 0 is no |
| | | | compression |
| 20 . . . | 32 bit unsigned | Count of events in | Repeats for |
| | int | bin (0, 0) of the | subsequent bins |
| | | histogram | |

Dotplot

| Offset | Type | Content | |
|---|---|---|---|
| 0 | 32 bit | 2 | Type of entity. 2 for a |
| | unsigned int | | dotplot |
| 4 | 32 bit | Length | Length in bytes of |
| | unsigned int | | entity including |
| | | | headers |
| 8 | 32 bit | Plot ID | Must be unique within |
| | unsigned int | | the message |
| 12 | 32 bit | Number of | Only 128 and 64 is |
| | unsigned int | channels in the | supported, and the |
| | | bitmap | bitmap must be |
| | | | square, i.e. 64x64 |
| 16 | 32 bit | Number of bitmap | Number of layers |
| | unsigned int | layers | currently being |
| | | | computed |
| 20 | 32 bit | Gate ID of 1^{st} | Identifies the gate |
| | unsigned int | bitmap | |
| 24 | 32 bit | Population ID of 1^{st} | Identifies the |
| | unsigned int | bitmap | population within the |
| | | | gate when the gate |
| | | | generates multiple |
| | | | populations |
| 28 | 32 bit | Compression | Method of |
| | unsigned int | method | compression. 0 is no |
| | | | compression |
| 32 . . . | 32 bit | Bits 0 . . . 31 in row 0 | Repeats for |
| | unsigned int | of the bitmap | subsequent bits. Bit 0 |
| | | | is (0, 0) and Bit 31 is |
| | | | (0, 31) |

### 3. Flow Diagram

The data is generated by the instrument and eventually is processed by the compute engine for the application. The main purpose of the compute engine is to process the raw event data into results that can be displayed to the user. The results are histograms as mentioned earlier and they are compact in nature so they can be transmitted quickly on a wire protocol.

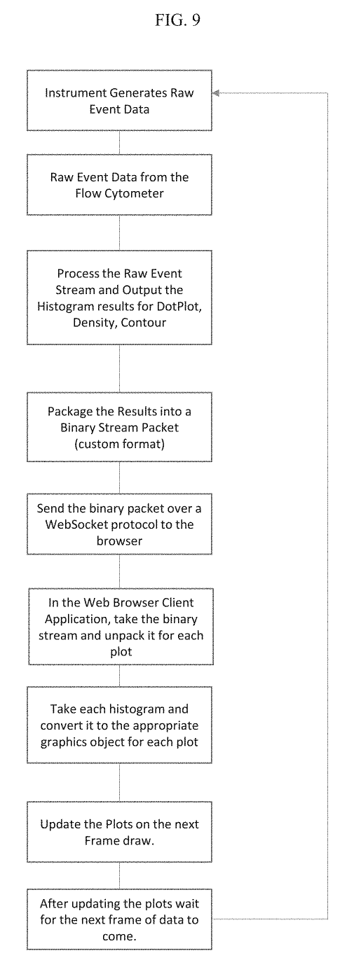

To display data in a browser, a websocket protocol is used. This is a higher-level abstraction on top of TCP/IP. The binary stream is compatible with the websocket protocol and the speed is fast enough to generate ‘real-time’ plot visualizations at least 10 frames per second. Here is the flow chart depicting data flow from the instrument to plot visualization in the browser. See FIG. 9.

Aspects of the present disclosure further include computer controlled systems for practicing the subject methods, where the systems further include one or more computers for complete automation or partial automation of a system for practicing methods described herein. In some embodiments, systems include a computer having a computer readable storage medium with a computer program stored thereon, where the computer program when loaded on the computer includes instructions for capturing one or more images of a flow stream of the flow cytometer in a detection field; algorithm for determining the spatial position of the flow stream in the detection field; algorithm for generating a data signal corresponding to the spatial position of the flow stream; and instructions for adjusting one or more parameters of the flow cytometer in response to the data signal. In certain instances, systems include a computer having a computer readable storage medium with a computer program stored thereon, where the computer program when loaded on the computer includes instructions for capturing one or more images of a flow stream of the flow cytometer in a detection field; algorithm for determining the physical dimensions of the flow stream in the detection field; algorithm for generating a data signal corresponding to the physical dimensions of the flow stream; and instructions for adjusting one or more parameters of the flow cytometer in response to the data signal.

In embodiments, the system includes an input module, a processing module and an output module. Processing modules of interest may include one or more processors that are configured and automated to adjust one or more parameters of a flow cytometer as described above. For example processing modules may include two or more processors that are configured and automated to adjust one or more parameters of a flow cytometer as described above, such as three or more processors, such as four or more processors and including five or more processors.

In some embodiments, the subject systems may include an input module such that parameters or information about the fluidic sample, sheath fluid pressure, hydrostatic pressure, flow stream charge, deflection voltage, charge correction value, drop delay, drop drive frequency, drop amplitude and charge phase, flow cell nozzle orifice, position of support stages, imaging sensors, light sources, optical adjustment protocols, amplifiers as well as properties, resolution and sensitivity of imaging sensors may be input before practicing the subject methods.

As described above, each processor includes memory having a plurality of instructions for performing the steps of the subject methods, such as capturing one or more images of a flow stream of the flow cytometer in a detection field; determining one or more properties of the flow stream in the detection field; generating a data signal corresponding to the one or more properties of the flow stream; and adjusting one or more parameters of the flow cytometer in response to the data signal. After the processor has performed one or more of the steps of the subject methods, the processor may be automated to make adjustments to parameters of the flow cytometer, such as adjustments as described above.

The subject systems may include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system.

Systems may include a display and operator input device. Operator input devices may, for example, be a keyboard, mouse, or the like. The processing module includes a processor which has access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The processor may be a commercially available processor or it may be one of other processors that are or will become available. The processor executes the operating system and the operating system interfaces with firmware and hardware in a well-known manner, and facilitates the processor in coordinating and executing the functions of various computer programs that may be written in a variety of programming languages, such as Java, Perl, C++, other high level or low level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the processor can store and retrieve data, such as magnetic, optical, or solid state storage devices (including magnetic or optical disks or tape or RAM, or any other suitable device, either fixed or portable). The processor may include a general purpose digital microprocessor suitably programmed from a computer readable medium carrying necessary program code. Programming can be provided remotely to processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT®, Windows XP, Windows 7, Windows 8, iOS, Sun Solaris, Linux, OS/400, Compaq Tru64 Unix, SGI IRIX, Siemens Reliant Unix, and others.

The subject systems, methods, and computer systems find use in a variety of different applications where it is desirable to automate adjustments of a flow stream of a flow cytometer to provide for fast, reliable systems for characterizing and sorting cells from a biological sample. Embodiments of the present disclosure find use where minimizing the amount of reliance on human input and adjustments to the system are desired, such as in research and high throughput laboratory testing. The present disclosure also finds use where it is desirable to provide a flow cytometer with improved cell sorting accuracy, enhanced particle collection, systems which provide alerts regarding component malfunction (e.g., clogged flow cell nozzle), reduced energy consumption, particle charging efficiency, more accurate particle charging and enhanced particle deflection during cell sorting. In embodiments, the present disclosure reduces the need for user input or manual adjustment during sample analysis with a flow cytometer. In certain embodiments, the subject systems provide fully automated protocols so that adjustments to a flow cytometer during use require little, if any human input.

The present disclosure also finds use in applications where cells prepared from a biological sample may be desired for research, laboratory testing or for use in therapy. In some embodiments, the subject methods and devices may facilitate the obtaining individual cells prepared from a target fluidic or tissue biological sample. For example, the subject methods and systems facilitate obtaining cells from fluidic or tissue samples to be used as a research or diagnostic specimen for diseases such as cancer. Likewise, the subject methods and systems facilitate obtaining cells from fluidic or tissue samples to be used in therapy. Methods and devices of the present disclosure allow for separating and collecting cells from a biological sample (e.g., organ, tissue, tissue fragment, fluid) with enhanced efficiency and low cost as compared to traditional flow cytometry systems.

The systems and methods of the invention may be employed in any convenient flow cytometer system. Suitable flow cytometer systems and methods for analyzing samples include, but are not limited to those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSVantage™, BD Biosciences FACSort™, BD Biosciences FACSCount™, BD Biosciences FACScan™, and BD Biosciences FACSCalibur™ systems, a BD Biosciences Influx™ cell sorter, BD Biosciences Jazz™ cell sorter and BD Biosciences Aria™ cell sorter or the like.

In certain embodiments, the subject systems are flow cytometer systems which incorporate one or more components of the flow cytometers described in U.S. Pat. Nos. 3,960,449; 4,347,935; 4,667,830; 4,704,891; 4,770,992; 5,030,002; 5,040,890; 5,047,321; 5,245,318; 5,317,162; 5,464,581; 5,483,469; 5,602,039; 5,620,842; 5,627,040; 5,643,796; 5,700,692; 6,372,506; 6,809,804; 6,813,017; 6,821,740; 7,129,505; 7,201,875; 7,544,326; 8,140,300; 8,233,146; 8,753,573; 8,975,595; 9,092,034; 9,095,494 and 9,097,640; the disclosures of which are herein incorporated by reference.

Although the foregoing invention has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A system for manipulating flow cytometric data.

2. A method for manipulating flow cytometric data.
